(19) United States
(12) Patent Application Publication
(10) Pub. No.: US 2006/0053669 A1
(43) Pub. Date: Mar. 16, 2006

(54) Method and apparatus for indicating a configurable switch

(75) Inventors: Erik Roehl, Batavia, IL (US); Martin Camins, Waterloo (CA)

Correspondence Address: BAKER & HOSTETLER LLP;Washington Square, Suite 1100, 1050 Connecticut Avenue, N.W., WASHINGTON, DC, 20036, US

(73) Assignee: Edwards Systems Technology, Inc.

(21) Appl. No.: 10/941,864

(22) Filed: Sep. 16, 2004

(51) Int. Cl. G09F 3/18

(52) U.S. Cl. 40/661

(57) ABSTRACT

The present invention enables institutions to identify and define specific patient and staff communication needs, and then configure nurse call switches accordingly. The facility administrators are able to customize the switches by placing their own colors, fonts, and text on removable label strips. The strips are removably positioned adjacent to activation switches. The specifically configured activation switches enable a particular healthcare facility to more effectively respond to different situations, some of which may be unique to the particular institution.

### FIELD OF THE INVENTION

The present invention relates generally to identifying objects. More particularly, the present invention relates to identifying configurable switches for a communication device.

### BACKGROUND OF THE INVENTION

Communication devices such as nurse call systems, which are used by numerous healthcare facilities, have been in use for many years. The basic purpose of a nurse call system is to provide a device for a patient whereby the patient is able to contact the healthcare staff. Initially nurse call systems were rudimentary in nature such that a call was placed to the staff with no indication of what the patient required. Nurse call systems have evolved to provide additional functionality for signaling and alerting staff to standard emergency and non-emergency situations common to most healthcare facilities. However, these evolved nurse call systems are not dynamic to each facility's unique requirements. More specifically, conventional nurse call systems are not capable of being modified in order to particularly address each of the many departments and their related needs located within in a single healthcare facility.

Conventional nurse call systems enable patients to communicate only a few standard events to the staff. Events such as code blue, routine, emergency, bathroom, and urgent are typically represented by factory stock switches located on known nurse call systems. These standard event switches are labeled by the manufacturer before the product is shipped to the consumer. When using these conventional nurse call devices, patients must select a generic switch from among the few factory stock switches located on the call device. These conventional systems are unable to specifically communicate special needs that are common to patients admitted to a particular department within a healthcare facility.

Healthcare providers, such as hospitals, are constantly analyzing internal procedures in order to provide better service while at the same time achieve increased efficiency. One such way is to enable a patient to communicate their specific needs through a nurse call system. Accordingly, it is desirable to provide a method and apparatus that enables an institutional facility to achieve its goals by configuring the nurse call system such that it can identify and define specific needs through configurable switches.

Institutions, such as hospitals, will be able to customize the switches using their own colors, fonts, and text. As a result, the nurse call system will be capable of more effectively responding to different situations, some of which may be unique to the particular institution's requirements.

### SUMMARY OF THE INVENTION

The foregoing needs are met, to a great extent, by the present invention, wherein in one aspect an apparatus is provided that in some embodiments institutions, such as hospitals, is able to customize a nurse call system by customizing its switch indicators. As a result, the nurse call system is capable of more effectively responding to different situations, some of which may be unique to the particular institution's requirements.

In accordance with one embodiment of the present invention, an apparatus is provided for identifying an object, includes a receptacle positioned adjacent to an activation device. A strip located within the receptacle, wherein the strip contains a marking in order to identify the activation device. The receptacle is located between two membranes. The strip is also removably located in the receptacle. The first membrane is a laminate having activation and indication devices disposed therein. The indicator marking is visible through the second membrane.

In accordance with an alternate embodiment of the present invention, an apparatus is provided for identifying an object, includes a receptacle positioned adjacent to an activation device. A strip is configured to be located within the receptacle, wherein the strip has an indicator marking such that it identifies the activation device. The apparatus can further include a first membrane, a second membrane, and a third membrane. The receptacle is located between the first and second membranes, and the strip is located in the receptacle such that it can be removed. The activation and indication devices are located between the second and third membranes. The indicator marking is visible through the third membrane, the activation device, and the second membrane.

In accordance with another aspect of the present invention, method for identifying an object that includes positioning a removable strip within a receptacle, wherein the receptacle is adjacent to an activation device and identifying the activation device with the strip, wherein an indicator marking is located on the strip.

In accordance with yet another aspect of the present invention, a system for identifying an object that includes means for identifying, and means for removably locating the means for identifying, wherein the means for identifying is configured to receive a marking.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front view of a nurse call device that incorporates the use of the present invention.

FIG. 2 is an exploded perspective view of a nurse call device that incorporates the use of the present invention.

FIG. 3 is another exploded view illustrating the membrane panel according to the preferred embodiment of the invention.

FIG. 4 is a cross-sectional side view illustrating the membrane panel according to an alternate embodiment of the present invention.

FIG. 5 is a front view of a membrane that incorporates removable label strips according to an alternate embodiment of the invention.

FIG. 6 is a rear view of the membrane in FIG. 5. The rear view illustrates the receptacles for holding label strips.

### DETAILED DESCRIPTION

An embodiment in accordance with the present invention provides configurable switches that enable institutional facilities to uniquely customize a communication device. The present invention enables institutions, such as hospitals, to identify and define specific patient and staff communication needs, and then customize switch indicators accordingly. The facility administrators are able to customize the switches using their own colors, fonts, and text. The specifically configured nurse call device switches enable a particular healthcare facility to more effectively respond to different situations, some of which may be unique to the particular institution. The present invention enables healthcare facilities to adjust to continuously changing needs and circumstances by providing an apparatus and method for easily customizing nurse call system switch indicators.

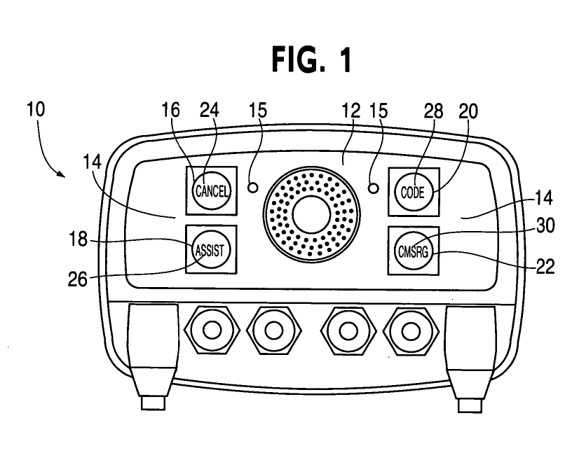

The invention will now be described with reference to the drawing figures, in which like reference numerals refer to like parts throughout. FIG. 1 is a front view of a nurse call device 10 that incorporates the present invention, the membrane panel 12, in accordance with the preferred embodiment. The user interface area 14, which is located on the front of the membrane panel 12, is also depicted in accordance with the preferred embodiment. Disposed within the membrane panel 12 are LEDs 15, switches 16, 18, 20,22, and indicator markings 24, 26, 28, 30. The indicator markings 24, 26, 28, 30 indicate the specific message that will be communicated to the facility staff when the switch that corresponds with the marking is activated. The indicator markings 24,26,28,30 are customized by the institutional facility administrators.

In the preferred embodiment, patients can select among the available switches 16, 18, 20, 22 and activate a desired switch by applying pressure to the corresponding area located on the user interface 14. For example, the patient may use his/her finger to depress the portion of the user interface area 14 that corresponds with the desired switch. Because the switches 16, 18, 20, 22 are located behind the user interface area 14, the pressure applied to the user interface 14 will activate the switch that corresponds with where the pressure is applied.

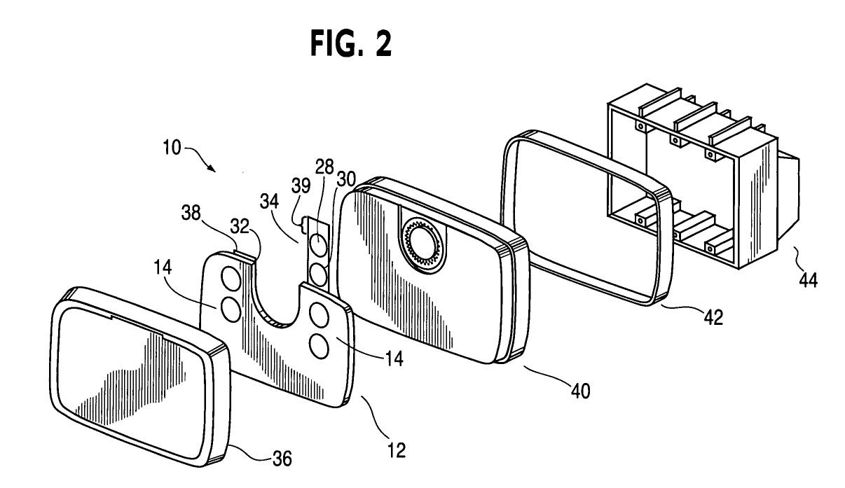

FIG. 2 is an exploded perspective view of the nurse call device 10 that incorporates the membrane panel 12 in accordance with the preferred embodiment. The removable label strips 32, 34, on which indicator markings 24, 26, 28, 30 are placed, are constructed such that they can be removably positioned inside receptacles that are formed within the membrane panel 12. Because the user interface area 14 is located on the front of the membrane panel 12 and the indicator markings 24, 26, 28, 30 are located within the membrane panel 12, the membrane panel 12 is constructed such that the markings 24, 26, 28, 30 are visible through the membrane panel 12.

A trim bezel 36 surrounds the outer perimeter of the membrane panel 12 and functions to protect and secure the membrane panel 12. The trim bezel 36 also conceals the protruding portions 38, 39 of the removable label strips 32, 34. The device 10 further includes a main enclosure 40, a frame 42, and a gang box 44, which combine to enclose and protect the internal electrical components of the nurse call device 10. A ribbon cable (not shown) enables communication between the membrane panel 12 and the nurse call device 10.

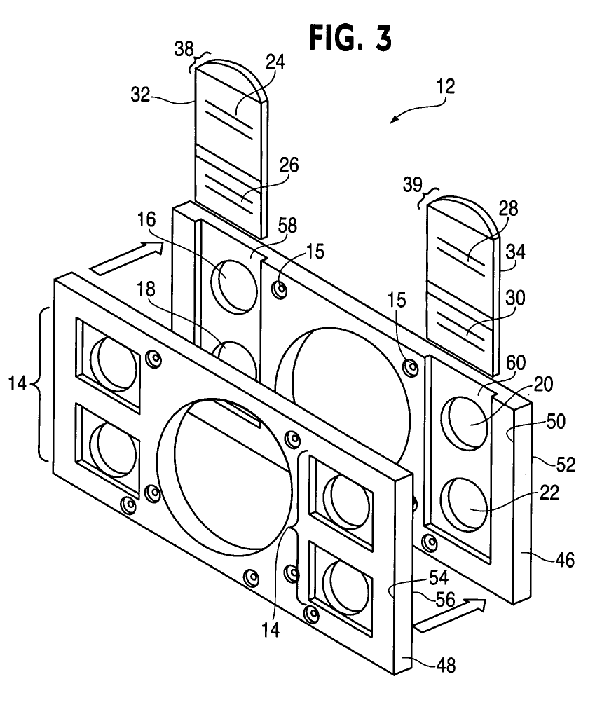

The preferred embodiment of the present inventive apparatus is illustrated in FIG. 3, wherein FIG. 3 is an exploded view of the membrane panel 12. The membrane panel 12 is composed of various components including a first membrane 46 and a second membrane 48. The first membrane 46 is composed of several layers of laminated plastic-like sheets and has a front side 50 and a rear side 52. The second membrane 48 is a single plastic-like sheet and has a front side 54 and a rear side 56. The first and second membranes 46, 48 are designed such that they are adhered to one another. For example, portions of the front side 50 of the first membrane 46 and portions of the rear side 56 of the second membrane 48 are coated with an adhesive material. Because of the adhesive coating, the front side 50 of the first membrane 46 is adhered to the rear side 56 of the second membrane 48.

In the preferred embodiment as shown in FIG. 3, portions are cutout of the front side 50 of the first membrane 46. When the first and second membranes 46, 48 are adhered together, these cutout portions create receptacles 58, 60.

The receptacles 58, 60 serve to hold the removable label strips 32, 34. For example, the respective receptacle 58, 60 dimensions are marginally larger than the respective strip 32, 34 dimensions. The receptacles 58, 60 are smooth and adhesive-free such that the removable label strips 32, 34 can freely slide in and out of position in the membrane panel 12. When the strips 32, 34 are in their respective positions inside the receptacles 58,60, the markings 24, 26, 28, 30 are visible through the second membrane 48 from the perspective of the user.

Because the removable label strips 32, 34 are handled by their respective top portions 38, 39 and are thereby moved in and out of the receptacles 58, 60, the strips 32, 34 are made of a physically stable polyester film with excellent transparency, such as polyethylene terepthalate.

The material of the strips 32, 34 is selected such that it can endure the forces incurred during repeated installation and removal. Without such material, the strips 32, 34 will lose their integrity and shape. If the strips 32, 34 lose their integrity or shape, the markings 24, 26, 28, 30 become distorted, and therefore, tend to become unidentifiable. Also the strip 32, 34 material is selected such that the marking 24, 26, 28, 30 will not smear or distort when handled.

In the preferred embodiment as shown in FIG. 3, the first membrane 46 is composed of several laminated layers of plastic-like sheet material. Dome switches 16, 18, 20, 22 and LEDs 15 are secured within the first membrane 46, between the laminated sheets of plastic-like material.

In the preferred embodiment as shown in FIG. 3, the portions of the second membrane 48 that correspond with the markings 24, 26,28, 30, when the strips 32, 34 are positioned in the receptacles 58, 60, are substantially clear so the markings are visible through the second membrane 48. If the portions of the second membrane 48 that cover markings 24, 26, 28, 30 are not substantially clear, then the markings will be concealed by the non-clear portions of the second membrane 48, and therefore, would be difficult to view from the perspective of the user.

In the preferred embodiment as shown in FIG. 3, the second membrane 48 is made of a material capable of withstanding pressure incurred from repeated use. During use, pressure occurs at the user interface area 14, which is located on the front side 54 of the second membrane 48. For example, when the user activates a switch 16, 18, 20, 22 and thereby signals the staff, the activation is effectuated by physical contact with the user interface area 14. The second membrane 48 is therefore made of a durable plastic-like material, that is capable of withstanding this repeated pressure and has excellent transparency, such as polyethylene terepthalate.

In the preferred embodiment, the rear side 52 of the first membrane 46 is coated with an adhesive material in order to secure the membrane panel 12 to the main enclosure 40 (see FIG. 2).

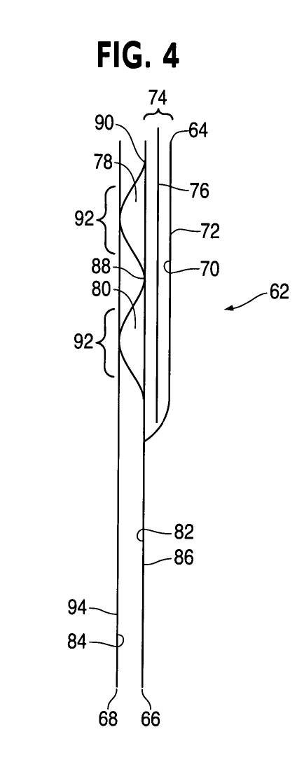

FIG. 4 is a cross-sectioned side view illustrating a membrane panel 62 according to an alternate embodiment of the present invention. As shown in FIG. 4, the membrane panel 62 has a first 64, second 66, and third 68 membrane. The first membrane 64 has a front side 70 and a rear side 72. The front side 70 of the first membrane 64 makes up a portion of a receptacle 74 for holding the removable label strip 76. When the strip 76 is located in the receptacle 74, it is adjacent to the front side 70 of the first membrane 64. The front side 70 of the first membrane 64 is a smooth, adhesive-free surface against which the removable label strip 76 can freely slide. The rear side 72 of the first membrane 64 is coated with an adhesive material in order to help secure the membrane panel 62 to the main enclosure 40 (see FIG. 2).

In the alternate embodiment as shown in FIG. 4, dome switches 78, 80 and LEDs (not shown) are located between the front side 82 of the second membrane 66 and the rear side 84 of the third membrane 68. The second and third membranes 66, 68 are laminated together, and thereby, the switches 78, 80 and LEDs (not shown) are secured between. The switches 78, 80 are located in front of the indicator makings (not shown), which are located on the strip 76. Despite being located behind the switches 78, 80, the indicator markings are visible through the switches 78, 80 because the switches 78, 80 are transparent.

In the alternate embodiment as shown in FIG. 4, the second membrane 66 has a front side 82 and a rear side 86. The front side 82 of the second membrane 66 is located adjacent to the respective bases 88, 90 of the dome switches 78, 80. The second membrane 66 is clear so the markings on the removable label strip 76 are visible through the second membrane 66. More specifically, in the alternate embodiment, unless the third membrane 68, the dome switches 78, 80, and the second membrane 66 are substantially clear to the extent that they cover indicator markings, the markings are not visible from the perspective of the user because the markings will be concealed by the non-clear portions of the second membrane 66, the dome switches 78, 80, and the third membrane 68.

In the alternate embodiment as shown in FIG. 4, the third membrane 68 is made of a material that is capable of withstanding pressure incurred from repeated user contact. The contact occurs at the user interface area 92, which is located on the front side 94 of the third membrane 68. Therefore, the third membrane 68 is made of a durable plastic-like material that has excellent transparency, for example, polyethylene terepthalate.

In the alternate embodiment as shown in FIG. 4, the user interface area 92, which is located on the front side 94 of the third membrane 68, is configured to correspond with the dome switches 78, 80. Locations may be formed in user interface area 92 that correspond with the locations of the clear dome switches 78, 80 and the LEDs. These locations are formed by molding indentions into third membrane 68, and the indentions correspond with the dome switch and LED locations.

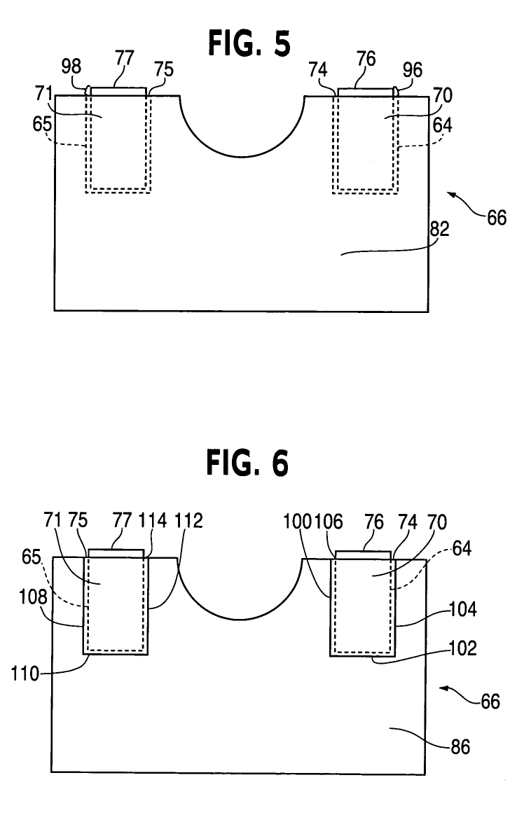

The alternate embodiment is further illustrated in FIG. 5. FIG. 5 is a front view of the front side 82 of the second membrane 66 in accordance with the alternate embodiment. In the alternate embodiment and as depicted in FIG. 5, there are two first membranes 64, 65. The two first membranes 64, 65 are attached to the rear side 86 of the second membrane 66, which is opposite the side 82 shown is FIG. 5. The two first membranes 64, 65 are indicated in FIG. 5 by the outer perimeter of hidden lines. FIG. 5 also shows two removable label strips 76, 77 positioned between the rear side 86 of the second membrane 66 and the front sides 70, 71 of the two respective first membranes 64, 65. The label strips 76, 77 are shown by the inner perimeter of hidden lines. The hidden lines do not represent the entire removable label strips 76, 77 because a small top portion 96, 98 of each strip 76, 77 extends beyond the area of the second membrane 66. These top portions 96, 98 are indicated by solid lines. The top portions 96, 98 enable facility administrators to handle the strips 76, 77 and thereby remove the strips 76, 77 when necessary to update the markings.

The alternate embodiment is further illustrated in FIG. 6. FIG. 6 is view of the rear side 86 of the second membrane 66 and also shows the rear sides 70, 71 of the first membranes 64, 65 in accordance with the alternate embodiment. The hidden lines shown in FIG. 6 represent the location and shape of the removable label strips 76, 77. In the alternate embodiment, in order to form an entryway to the receptacles 74, 75 which house the removable label strips 76, 77, only a portion of the first membranes' 64, 65 respective outer perimeters are attached to the rear side 86 of the second membrane 66. The attached portion of the first membranes' 64, 65 respective outer perimeters are defined by edges 100, 102, 104, 106 and 108, 110, 112, 114. An adhesive means is applied only to the outer most portion of edges 100, 102, 104 and 108, 110, 112. Because only the outer most portion of edges 100, 102, 104 and 108, 110, 112 are exposed to adhesive means, and because edges 106 and 114 are not exposed adhesive means, entryways to receptacles 74, 75 are created for housing the removable label strips 76, 77.

Although an example of the device 10 is shown a membrane panel 12 that has two membranes 46, 48, and an other example is shown having membrane panel 62 that has four membranes 64, 65, 66, 68, it will be appreciated that the membrane panel may comprise more or less membranes than illustrated and discussed. Also, although the device 10 is useful to improve nurse call systems, it can also be used to improve other types of communication devices. The device may be used in institutional facilities beyond the scope of healthcare facilities.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for identifying an object, comprising:
a receptacle positioned adjacent to an activation device; and
a strip configured to be located within the receptacle, wherein the strip is further configured to receive an indicator marking such that it identifies the activation device.

2. An apparatus according to claim 1, wherein the strip is removably positioned.

3. An apparatus according to claim 1, wherein the strip is made of a polyethylene terepthalate film.

4. An apparatus according to claim 1, further comprising a first and a second membrane.

5. An apparatus according to claim 4, wherein the receptacle is defined by an area between the first membrane and the second membrane.

6. An apparatus according to claim 4, wherein the first membrane is a laminate having the activation device disposed therein.

7. An apparatus according to claim 4, wherein a plurality of portions of the second membrane is clear so the indicator marking is viewable through the second membrane.

8. An apparatus according to claim 4, where in the first and second membranes are made of a polyethylene terepthalate film.

9. An apparatus according to claim 1, further comprising a first membrane, a second membrane, and a third membrane.

10. An apparatus according to claim 9, wherein the first membrane has an outer perimeter, and a portion of the outer perimeter is attached to the second membrane.

11. An apparatus according to claim 9, wherein the receptacle is defined by an area between the first membrane and the second membrane.

12. An apparatus according to claim 9, wherein the second membrane has a front surface and the third membrane has a rear surface, and the front surface is adhered to the rear surface and the activation device is secured between.

13. An apparatus according to claim 9, wherein the indicator marking is visible through the activation device, the third membrane, and the second membrane.

14. A method for identifying an object, comprising:
positioning a strip within a receptacle, wherein the receptacle is adjacent to an activation device; and
identifying the activation device with the strip, wherein an indicator marking is located on the strip.

15. A method according to claim 14, wherein the strip is removably positioned.

16. A method according to claim 14, further comprising a first and a second membrane.

17. A method according to claim 16, wherein the receptacle is defined by an area between the first membrane and the second membrane.

18. A method according to claim 16, wherein the first membrane is a laminate having the activation device disposed therein.

19. A method according to claim 16, wherein a plurality of portions of the second membrane are substantially clear.

20. A system for identifying an object, comprising:
means for identifying a means for activating; and
means for removably locating the means for identifying, wherein the means for identifying is configured to receive an indicator marking.

21. A system according to claim 20, wherein the means for identifying is removably positioned.

22. A system according to claim 20, further comprising a first and a second membrane.

23. A system according to claim 22, wherein the means for removably locating is defined by an area between the first membrane and the second membrane.

24. A system according to claim 22, wherein the first membrane is a laminate having the means for activating disposed therein.

25. A system according to claim 22, wherein a plurality of portions of the second membrane is clear so the indicator marking is visible through the second membrane.
